(19) United States
(12) Patent Application Publication
(10) Pub. No.: US 2026/0093156 A1
(43) Pub. Date: Apr. 2, 2026

(54) ACCELEROMETER-BASED TRIGGER SYSTEM FOR RIDE CAMERAS ON AMUSEMENT ATTRACTIONS

(71) Applicant: Super Selfie, Inc., Zephyr Cove, NV (US)

(72) Inventors: Greg SHIRAKYAN, Reno, NV (US); Paul LAINE, Reno, NV (US); Alex SANTOS, Reno, NV (US); Donald CHAPMAN, Reno, NV (US)

(21) Appl. No.: 19/347,391

(22) Filed: Oct. 1, 2025

Related U.S. Application Data
(60) Provisional application No. 63/701,946, filed on Oct. 1, 2024.

(51) Int. Cl. G03B 7/26; A63G 7/00; G01P 15/18

(52) U.S. Cl. CPC G03B 7/26; A63G 7/00; G01P 15/18

(57) ABSTRACT

A system has an amusement attraction track. An amusement attraction vehicle is operative on the amusement attraction track. The amusement attraction vehicle includes an accelerometer and a microcontroller. The microcontroller collects signals from the accelerometer to selectively generate a camera state signal. A camera is responsive to the camera state signal to selectively turn the camera on and off.

### CROSS REFERENCE TO RELATED APPLICATION

This application claims priority to U.S. Provisional Patent Application 63/701,946, filed Oct. 1, 2024, the contents of which are incorporated herein by reference.

### FIELD OF THE INVENTION

This invention relates generally to electronic systems associated with amusement attractions. More particularly, this invention is directed to an accelerometer-based trigger system for ride cameras on amusement attractions.

### BACKGROUND OF THE INVENTION

Amusement parks and similar entertainment venues often feature rides equipped with cameras to capture memorable moments of guests' experiences. Traditional camera triggering methods involve external sensors—such as infrared beams, proximity sensors, pressure plates, etc.—installed along the ride's path. These sensors detect when a ride vehicle passes specific points and send signals to the camera system to start or stop recording.

However, this approach has several drawbacks:
Installation and Maintenance Costs: External sensors require significant investment for installation and are exposed to environmental factors that necessitate regular maintenance.
Environmental Vulnerability: Weather conditions, physical obstructions, and wear and tear can affect sensor performance.
Complex Vehicle Identification: When multiple vehicles are on the track simultaneously, the system must accurately identify which vehicle is passing to trigger the correct recording sequence, often requiring additional complex systems for vehicle identification and communication.
Inflexibility: Adjusting the system for changes in the ride or adding new features often involves physical modifications to the sensors or their placements.

Thus, there is a need for techniques to overcome problems associated with prior art systems.

### SUMMARY

A system has an amusement attraction track. An amusement attraction vehicle is operative on the amusement attraction track. The amusement attraction vehicle includes an accelerometer and a microcontroller. The microcontroller collects signals from the accelerometer to selectively generate a camera state signal. A camera is responsive to the camera state signal to selectively turn the camera on and off.

### BRIEF DESCRIPTION OF THE DRAWINGS

The invention is more fully appreciated in connection with the following detailed description taken in conjunction with the accompanying drawings, in which:

FIG. 1 illustrates a system configured in accordance with an embodiment of the invention.

### DETAILED DESCRIPTION

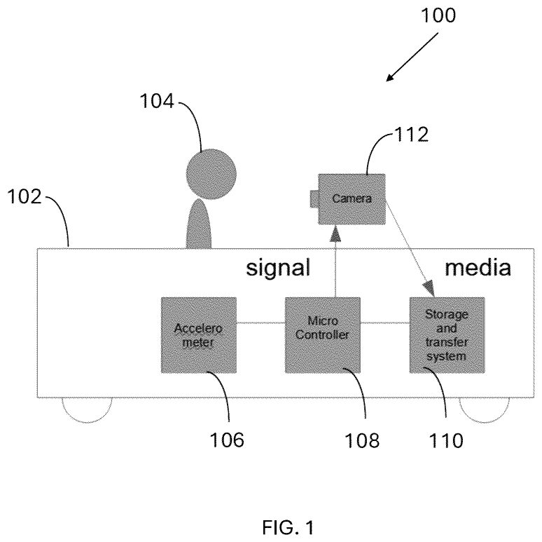

FIG. 1 illustrates a system 100 configured in accordance with an embodiment of the invention. The system 100 includes an amusement attraction vehicle 102, which carries a passenger 104. The vehicle 102 is operative on an amusement attraction track (not shown).

The vehicle 102 has an accelerometer 106, connected to a microcontroller 108, which is connected to a storage and transfer system 110. The microcontroller 108 is also connected to and controls camera 112. Camera 112 may be positioned on the vehicle 102 or may be external to the vehicle 102. The only positioning limitation is that it needs to have a view of the passenger 104.

Accelerometer 106: Is mounted within each ride vehicle. It measures acceleration forces across multiple axes in real-time.

Microcontroller 108: Is an onboard processing unit connected to the accelerometer. It is programmed to analyze acceleration data and execute camera triggers.

Storage and Transfer System: Is a wired or wireless system that transmits signals from the microcontroller 102 to the ride camera system 112 to initiate or terminate recordings specific to each vehicle.

Camera 112: Records a still or motion image of the guests and stores it on the local storage device or transfers the captured image to an external storage system.

### Operation:

Real-Time Data Monitoring: As the ride vehicle 102 moves, the accelerometer 106 continuously captures acceleration data.

Pattern Recognition Algorithm: The microcontroller 108 processes the acceleration data using predefined algorithms to identify unique acceleration signatures corresponding to specific sections of the ride (e.g., loops, drops, sharp turns). In one embodiment, a trigger to turn on the camera is initiated when the acceleration along a chosen axis exceeds a pre-determined threshold. The camera remains on during the acceleration event or for a period of time after the acceleration event.

Trigger Signal Transmission: When a matching acceleration pattern is detected, the microcontroller 108 sends a signal to the camera system 112 to start or stop recording for that specific vehicle 102.

Vehicle-Specific Communication: Since the trigger originates from the vehicle itself, the system inherently associates the recording commands with the correct vehicle, eliminating the need for external vehicle identification.

System Adjustability: Ride operators can update the microcontroller's software to adjust for ride modifications or to refine detection algorithms without physical changes to the hardware.

### Advantages

Accurate Vehicle Identification: By generating triggers from the vehicle itself, the system ensures that recordings are correctly associated with each individual vehicle, solving the problem of multiple vehicles on the track simultaneously.

Cost Efficiency: Reduces or eliminates the need for external sensors and complex vehicle identification systems, lowering installation and maintenance expenses.

Enhanced Reliability: Minimizes exposure to environmental factors that can impair external sensors, such as adverse weather or debris.

Simplified Implementation: Onboard components simplify installation and testing processes, as they are self-contained within each vehicle.

Flexibility and Scalability: Software-based adjustments allow for easy updates and scalability across different rides and configurations.

Improved Guest Experience: Provides precise timing for recordings, capturing the most thrilling moments for guests.

### Applications:

Amusement Rides with Multiple Vehicles: Roller coasters, mountain coasters, and similar attractions where multiple vehicles operate on the same track concurrently.

Mobile and Temporary Installations: Ideal for traveling fairs or seasonal attractions where quick setup and teardown are necessary, and installing external sensors is impractical.

Advanced Ride Experiences: Can be integrated with virtual reality (VR) and augmented reality (AR) systems to synchronize physical ride events with virtual content on a per-vehicle basis.

This invention presents an innovative approach to triggering ride cameras by utilizing an onboard accelerometer and microcontroller system within each ride vehicle. By detecting specific acceleration patterns, the system accurately triggers recordings at optimal moments and inherently solves the challenge of vehicle identification in multi-vehicle environments. This leads to improved reliability, reduced costs, and an enhanced experience for both operators and guests in the amusement ride industry.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include but are not limited to: magnetic media, optical media, magneto-optical media, and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using an object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A system, comprising:
an amusement attraction track;
an amusement attraction vehicle operative on the amusement attraction track, the amusement attraction vehicle including an accelerometer and a microcontroller, the microcontroller collecting signals from the accelerometer to selectively generate a camera state signal; and
a camera responsive to the camera state signal to selectively turn the camera on and off.

2. The system of claim 1 wherein the camera state signal is an on signal in response to the accelerometer measuring an acceleration signal that exceeds a pre-determined threshold along a chosen axis.

3. The system of claim 2 wherein the on signal persists while the acceleration signal exceeds the pre-determined threshold.

4. The system of claim 2 wherein the on signal persists for a period of time after the acceleration signal exceeds the pre-determined threshold.

5. The system of claim 1 wherein the camera is mounted on the amusement attraction track.

6. The system of claim 1 wherein the camera is mounted on the amusement attraction vehicle.
